(19) United States
(12) Patent Application Publication
(10) Pub. No.: US 2026/0087221 A1
(43) Pub. Date: Mar. 26, 2026

(54) DESIGN AND POWER-LOSS ANALYSIS METHODS FOR ACOUSTIC WAVE FILTERS

(71) Applicant: SKYWORKS SOLUTIONS, INC., Irvine, CA (US)

(72) Inventors: Yiliu Wang, Irvine, CA (US); Renfeng Jin, Irvine, CA (US)

(21) Appl. No.: 19/196,994

(22) Filed: May 2, 2025

Related U.S. Application Data
(60) Provisional application No. 63/643,549, filed on May 7, 2024.

(51) Int. Cl. G06F 30/367; G06F 119/06; H03H 9/54

(52) U.S. Cl. CPC G06F 30/367; H03H 9/54; G06F 2119/06

(57) ABSTRACT

A design method for an acoustic wave filter comprises setting up a first electrical circuit design of an acoustic wave filter having a plurality of series and shunt acoustic wave resonators, performing a power-loss analysis for each of the plurality of acoustic wave resonators separately, determining which of the acoustic wave resonators displays transient power dissipation which is most likely to lead to a thermal run-away event, setting up, based on the first electrical circuit design, a second electrical circuit design of the acoustic wave filter in which the acoustic wave resonator determined to most likely lead to a thermal run-away event is replaced with an open impedance, and performing a second power-loss analysis for each of the remaining acoustic wave resonators separately to determine which of the remaining acoustic wave resonators displays transient power dissipation which is most likely to lead to a thermal run-away event.

### CROSS-REFERENCE TO RELATED APPLICATIONS

This application claims priority under 35 U.S.C. § 119 (e) to U.S. Provisional Patent Application Ser. No. 63/643,549, titled “DESIGN AND POWER-LOSS ANALYSIS METHODS FOR ACOUSTIC WAVE FILTERS,” filed May 7, 2024, the entire content of which is incorporated herein by reference for all purposes.

### BACKGROUND

### Field

Aspects and embodiments disclosed herein relate to acoustic wave filters, and in particular to design methods and power-loss analysis methods of acoustic wave filters.

### Description of Related Technology

An acoustic wave filter can include a plurality of resonators arranged to filter radio frequency (RF) signals. Examples of acoustic wave resonators include surface acoustic wave (SAW) resonators and bulk acoustic wave (BAW) resonators. A surface acoustic wave resonator can include an interdigital transductor electrode on a piezoelectric substrate. A surface acoustic wave resonator can generate a surface acoustic wave on a surface of the piezoelectric substrate on which the interdigital transductor electrode is disposed. In BAW resonators, acoustic waves propagate in a bulk of a piezoelectric material layer. Example BAW resonators include film bulk acoustic wave resonators and solidly mounted resonators (SMRs).

Acoustic wave filters can be implemented in RF electronic systems. For instance, filters in a radio frequency front end (RFFE) of an RF communication system can include acoustic wave filters. Examples of RF communication systems include, but are not limited to, mobile phones, tablets, base stations, network access points, customer-premises equipment (CPE), laptops, and wearable electronics. An acoustic wave filter can be a band pass filter. A plurality of acoustic wave filters can be arranged as a multiplexer. For example, two acoustic wave filters can be arranged as a duplexer.

During the design phase of an acoustic wave filter, various analysis processes may be employed to identify acoustic wave resonators most vulnerable to failures or breakdowns. For example, simulating the dissipated power density over the operating frequency range of the acoustic wave filter may aid in predicting which of the acoustic wave resonators in an acoustic wave filter is most prone to failure. It would be desirable to increase design tolerance and yield of the manufacturing process of acoustic wave filters by improving the design process through more sophisticated simulation tools.

### SUMMARY

In certain embodiments, the present disclosure relates to a design method for an acoustic wave filter. The method includes setting up a first electrical circuit design of an acoustic wave filter having a plurality of series acoustic wave resonators and a plurality of shunt acoustic wave resonators. The method further includes performing a first power-loss analysis for each of the plurality of series acoustic wave resonators and the plurality of shunt acoustic wave resonators of the first electrical circuit design separately. The method further includes determining which of the analyzed acoustic wave resonators of the first electrical circuit design displays transient power dissipation which is most likely to lead to a thermal run-away event. The method further includes setting up, based on the first electrical circuit design, a second electrical circuit design of the acoustic wave filter in which the acoustic wave resonator determined to most likely lead to a thermal run-away event is replaced with an open impedance. The method further includes performing a second power-loss analysis for each of the remaining acoustic wave resonators of the second electrical circuit design separately to determine which of the analyzed remaining acoustic wave resonators displays transient power dissipation which is most likely to lead to a thermal run-away event.

According to several embodiments, the plurality of series acoustic wave resonators are BAW resonators. In some embodiments, the plurality of shunt acoustic wave resonators are BAW resonators. In a number of embodiments, the first and the second power-loss analyses are performed in a frequency range between 410 MHz and 7.125 GHz.

In various embodiments, determining which of the analyzed acoustic wave resonators of the first electrical circuit design displays transient power dissipation which is most likely to lead to a thermal run-away event includes determining whether a transient power dissipation of the analyzed acoustic wave resonators exceeds a predetermined power dissipation threshold.

In a few embodiments, the acoustic wave filter is a ladder-type acoustic wave filter. In several embodiments, the acoustic wave filter is a lattice-type or a hybrid ladder-lattice-type acoustic wave filter.

According to a number of embodiments, the acoustic wave filter is a band pass filter.

In some embodiments, the acoustic wave filter includes a first RF input/output port configured as a transmit port for a transmit filter or a receive port for a receive filter, and a second RF input/output port configured as an antenna port to be connected to an antenna.

According to a few embodiments, the method further includes setting up, based on the second electrical circuit design, a third electrical circuit design of the acoustic wave filter in which the acoustic wave resonator determined to most likely lead to a thermal run-away event in the second power-loss analysis is replaced with an open impedance. In a number of embodiments, the method further includes performing a third power-loss analysis for each of the remaining acoustic wave resonators of the third electrical circuit design separately to determine which of the analyzed remaining acoustic wave resonators displays transient power dissipation which is most likely to lead to a thermal run-away event.

In certain other embodiments, the present disclosure relates to a power-loss analysis method for an acoustic wave filter. The method includes initiating a frequency-dependent simulation of dissipated power of an electrical circuit design of an acoustic wave filter having a plurality of series acoustic wave resonators and a plurality of shunt acoustic wave resonators. The method further includes halting the simulation when the simulation reaches a stage in which transient power dissipation of a failing one of the plurality of series acoustic wave resonators and the plurality of shunt acoustic wave resonators exceeds a predetermined power dissipation threshold. The method further includes, upon halting the simulation, replacing the failing one of the plurality of series acoustic wave resonators and the plurality of shunt acoustic wave resonators with an open impedance in the electrical circuit design of the acoustic wave filter. The method further includes continuing the frequency-dependent simulation of dissipated power with the electrical circuit design of the acoustic wave filter in which the failing one of the plurality of series acoustic wave resonators and the plurality of shunt acoustic wave resonators has been replaced with an open impedance.

In a number of embodiments, the plurality of series acoustic wave resonators are BAW resonators. According to various embodiments, the plurality of shunt acoustic wave resonators are BAW resonators.

In several embodiments, the frequency-dependent simulation of dissipated power is performed in a frequency range between 410 MHz and 7.125 GHz.

According to a number of embodiments, the acoustic wave filter is a ladder-type acoustic wave filter. According to various embodiments, the acoustic wave filter is a lattice-type or a hybrid ladder-lattice-type acoustic wave filter. In a few embodiments, the acoustic wave filter is a band pass filter.

In several embodiments, the acoustic wave filter includes a first RF input/output port configured as a transmit port for a transmit filter or a receive port for a receive filter, and a second RF input/output port configured as an antenna port to be connected to an antenna.

In certain other embodiments, the present disclosure relates to a computer program product comprising instructions which, when the program is executed by a computer, cause the computer to carry out the steps of the power-loss analysis method for an acoustic wave filter according to some embodiments of the present invention.

In certain further embodiments, the present disclosure relates to a non-transitory computer-readable storage medium comprising instructions which, when executed by a computer, cause the computer to carry out a power-loss analysis method for an acoustic wave filter. The method comprises initiating a frequency-dependent simulation of dissipated power of an electrical circuit design of an acoustic wave filter having a plurality of series acoustic wave resonators and a plurality of shunt acoustic wave resonators. The method further includes halting the simulation when the simulation reaches a stage in which transient power dissipation of a failing one of the plurality of series acoustic wave resonators and the plurality of shunt acoustic wave resonators exceeds a predetermined power dissipation threshold. The method further includes, upon halting the simulation, replacing the failing one of the plurality of series acoustic wave resonators and the plurality of shunt acoustic wave resonators with an open impedance in the electrical circuit design of the acoustic wave filter. The method further includes continuing the frequency-dependent simulation of dissipated power with the electrical circuit design of the acoustic wave filter in which the failing one of the plurality of series acoustic wave resonators and the plurality of shunt acoustic wave resonators has been replaced with an open impedance.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

Embodiments of this disclosure will now be described, by way of non-limiting example, with reference to the accompanying drawings.

FIG. 1 is a cross-sectional view of a bulk acoustic wave (BAW) device.

FIG. 2 is a cross-sectional view of a Lamb wave resonator.

FIG. 3A is a flow diagram of a method for designing an acoustic wave filter according to an embodiment.

FIG. 3B is a flow diagram of a design method for an acoustic wave filter according to another embodiment.

FIG. 3C is a flow diagram of a power-loss analysis method for an acoustic wave filter according to another embodiment.

FIG. 4 is a schematic diagram of an acoustic wave filter in ladder topology according to another embodiment.

FIG. 5 is a schematic diagram of an acoustic wave filter in lattice topology.

FIG. 6 is a schematic diagram of an acoustic wave filter in hybrid ladder-and-lattice topology.

FIG. 7 is a schematic diagram of a further acoustic wave filter in ladder topology according to another embodiment.

FIG. 8 is a schematic diagram of two acoustic wave filters in ladder topology forming a duplexer according to another embodiment.

FIG. 9 is a schematic diagram of a plurality of acoustic wave filters forming a multiplexer according to another embodiment.

FIG. 10 is a schematic block diagram of a module that includes an antenna switch and duplexers that include one or more raised frame bulk acoustic wave devices.

FIG. 11 is a schematic block diagram of a module that includes a power amplifier, a radio frequency switch, and duplexers that include one or more acoustic wave resonators.

FIG. 12 is a schematic block diagram of a module that includes a low noise amplifier, a radio frequency switch, and acoustic wave filters that include one or more acoustic wave resonators.

FIG. 13 is a schematic block diagram of a module that includes a power amplifier, a radio frequency switch, and a duplexer that includes one or more acoustic wave resonators.

FIG. 14 is a schematic block diagram of a wireless communication device that includes acoustic wave filters with acoustic wave resonators.

FIG. 15 is a schematic block diagram of another wireless communication device that includes acoustic wave filters with acoustic wave resonators.

### DETAILED DESCRIPTION OF CERTAIN EMBODIMENTS

The following detailed description of certain embodiments presents various descriptions of specific embodiments. However, the innovations described herein can be embodied in a multitude of different ways, for example, as defined and covered by the claims. In this description, reference is made to the drawings in which like reference numerals can indicate identical or functionally similar elements.

It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

Acoustic wave filters, for example for filtering radio frequency signals in a fifth generation (5G) New Radio (NR) operating band within Frequency Range 1 (FR1) or Frequency Range 2 (FR2), are usually implemented with a number of acoustic wave resonators which are integrated upon one substrate and then singulated into individual dic.

A multiplexer, such as a duplexer, in accordance with any suitable principles and advantages disclosed herein, can include one or more acoustic wave filters arranged to filter a radio frequency signal in a 5G NR operating band within FR1. FR1 can be from 410 megahertz (MHz) to 7.125 gigahertz (GHz), for example, as specified in a current 5G NR specification. An acoustic wave filter of any of the embodiments disclosed herein can be arranged to filter a radio frequency signal in a fourth generation (4G) Long Term Evolution (LTE) operating band. An acoustic wave filter of any of the embodiments disclosed herein can have a passband that includes a 4G LTE operating band and a 5G NR operating band.

Acoustic wave resonators, including surface acoustic wave (SAW), bulk acoustic wave (BAW), and multi-layer piezoelectric substrate (MPS) resonators, can be used in radio frequency (RF) filters and communications systems. In some instances, the acoustic wave resonators can be exposed to relatively high RF power levels. Acoustic wave resonators can be limited in terms of how much RF power they can withstand without damage. These power limitations can be exacerbated by heat, such as from external heat sources (e.g. a higher ambient operating temperature), a nearby component (e.g., on a printed circuit board or RF system), or the resonator itself. Self-generated heat can be particularly problematic for high power operation. When an acoustic wave resonator is exposed to high power levels, some of that power can be dissipated within the resonator, generating heat and raising the temperature of the resonator and the surrounding environment. Under some circumstances, a positive feedback loop can occur where an increase in temperature causes higher levels of power dissipation, which can generate even more heat and can raise the temperature even further. This positive feedback loop can produce a thermal runaway event, such as if the increase in dissipated power outpaces the rate at which heat can be removed (e.g., through the surrounding environment). In some instances, the resonator temperature can rise until it can no longer withstand the applied power levels, which can result in electrical overstress (EOS) and, in some cases, irreparable damage to the resonator.

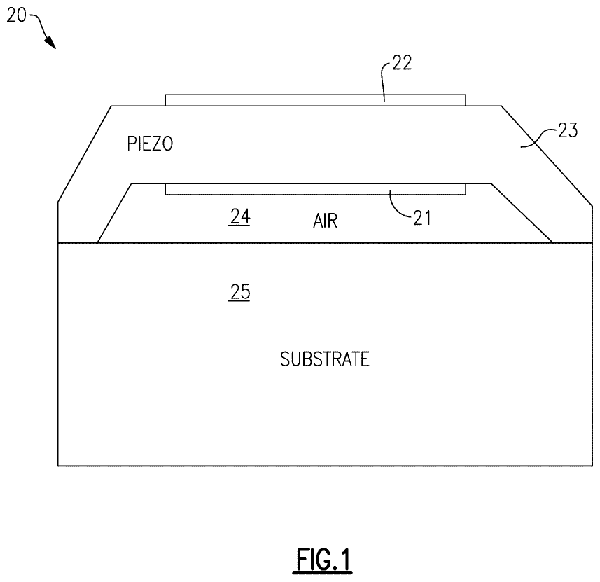

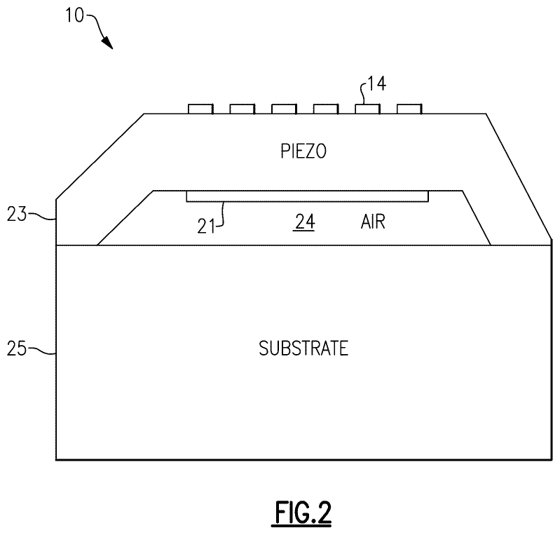

FIGS. 1 and 2 show possible devices that may be employed as resonators in acoustic wave filters and that may potentially be subject to thermal runaway events. For example, FIG. 1 is a cross sectional view of a bulk acoustic wave (BAW) device 20. The BAW device 20 can be a BAW resonator as used for example in an acoustic wave filter according to some of the embodiments disclosed herein. The illustrated BAW device 20 is a film bulk acoustic wave resonator. The BAW device 20 includes a first electrode 21, a second electrode 22, a piezoelectric material layer 23, an air cavity 24, and a substrate 25. The electrodes 21 and 22 are on opposing sides of the piezoelectric material layer 23. The piezoelectric material layer 23 can be a thin film. The piezoelectric material layer 23 can be an aluminum nitride layer, for example. In other instances, the piezoelectric material layer 23 can be any other suitable piezoelectric material layer. The air cavity 24 is disposed between the electrode 21 and the substrate 25. The substrate 25 can be a semiconductor substrate. For example, the substrate 25 can be a silicon substrate. The substrate 25 can be any other suitable substrate, such as a quartz substrate, a sapphire substrate, a spinel substrate, a ceramic substrate, a glass substrate, or the like. Although not shown in FIG. 1, the BAW device 20 can include a raised frame structure and/or a recessed frame structure.

FIG. 2 is a cross sectional diagram of a Lamb wave resonator 10. A Lamb wave resonator can implement one or more series resonators and/or one or more shunt resonators in an acoustic wave filter. The Lamb wave resonator 10 includes features of a SAW resonator and a film bulk acoustic wave resonator. As illustrated, the Lamb wave resonator 10 includes a piezoelectric material layer 23, an IDT electrode 14 on the piezoelectric material layer 23, and an electrode 21. The resonant frequency of the Lamb wave resonator 10 can be based on the thickness of the piezoelectric material layer 23 and/or the geometry of the IDT electrode 14. An air cavity 24 is disposed between the electrode 21 and a substrate 25. Although the Lamb wave resonator 10 of FIG. 2 is a free standing Lamb wave resonator, a solidly mounted resonator (SMR) Lamb wave resonator with a solid acoustic mirror (e.g., acoustic Bragg reflectors) can alternatively or additionally be implemented.

The development and design process for acoustic wave filters should take into account how resilient filters are against thermal events. Conventionally, resonators are analyzed one by one, simulating the dissipated power density per resonator over the operating frequency range. Using this conventional method, it is possible to predict the resonator most likely to fail first upon given operating power and frequency conditions. However, other resonators might display inconspicuous behavior in the one-by-one simulation of dissipated power density but still fail under actual operating conditions. Consequently, mitigation techniques, for example, introduction of protective circuitry elements may in some implementations only target the resonators predicted to be the ones most likely to fail, while other resonators in the filter may not be protected sufficiently.

Embodiments of this disclosure relate to design methods and power-loss analysis methods for acoustic wave filters. Such acoustic wave filters may for example be any of the acoustic wave filters 400, 90, or 100, as illustrated in and explained in conjunction with FIGS. 4, 5, and 6, respectively.

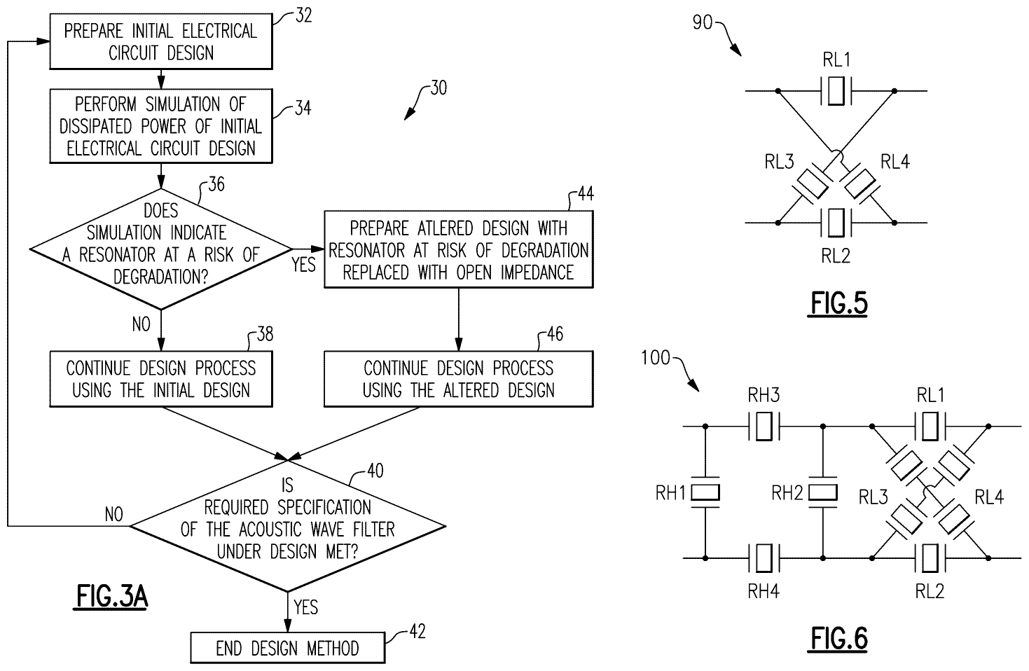

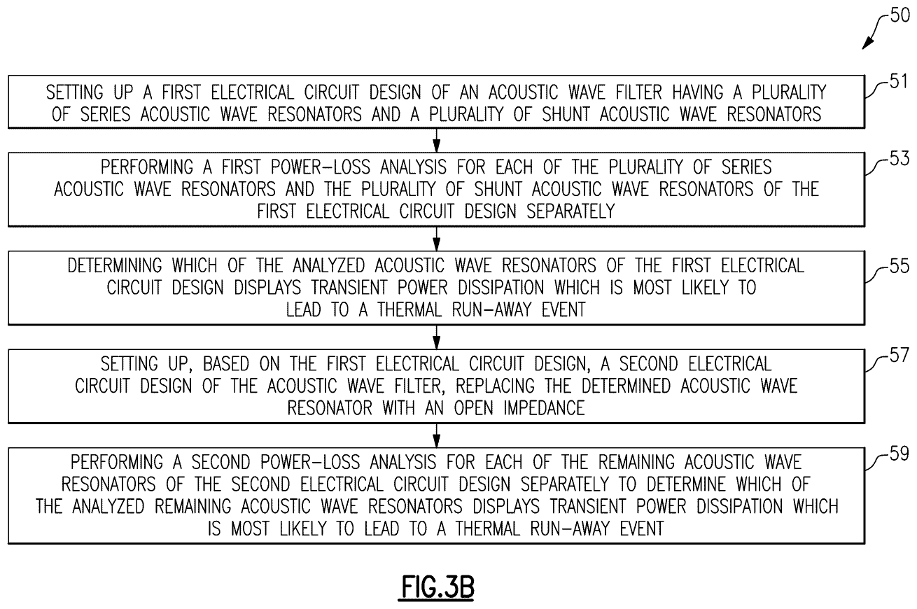

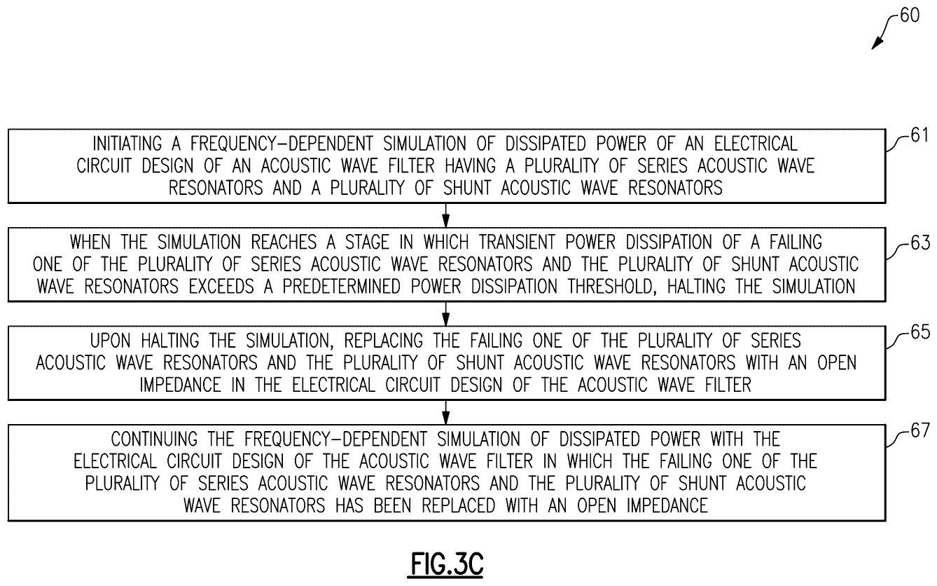

FIG. 3A is a flow diagram 30 of a method for designing an acoustic wave filter according to one embodiment. The acoustic wave filter to be designed may, for example, employ one or more BAW resonators such as illustrated in FIG. 1 and/or one or more Lamb wave resonators such as illustrated in FIG. 2.

In a first stage 32 the design process starts with an initial electrical circuit design of an acoustic wave filter. The acoustic wave filter may, for example, be a ladder-type acoustic wave filter, a lattice-type acoustic wave filter, or a hybrid ladder-lattice-type acoustic wave filter. The acoustic wave filter may, for example, be employed as a band pass filter in which a first RF input/output port of the acoustic wave filter is a transmit port for a transmit filter or a receive port for a receive filter, and a second RF input/output port of the acoustic wave filter is an antenna port configured to be connected to an antenna. The first electrical circuit design of the acoustic wave filter includes a plurality of series acoustic wave resonators and a plurality of shunt acoustic wave resonators. The series acoustic wave resonators and/or shunt acoustic wave resonators may, for example, be bulk acoustic wave (BAW) resonators or Lamb wave resonators.

Subsequently, a simulation of dissipated power is performed on the initial design in a second stage 34. The outcome of the simulation of dissipated power may yield an indication of which of the acoustic wave resonators of the acoustic wave filter in the initial design is at risk to degrade first under given operating power and frequency conditions in a decision stage 36.

If none of the acoustic wave resonators of the acoustic wave filter in the initial design is at risk to degrade, the design process is continued using the initial design in a stage 38. However, if there is an acoustic wave resonator identified which displays transient power dissipation most likely leading to a thermal runaway event, i.e., the acoustic wave resonator identified is at risk to degrade, the initial design is altered in a branch-off stage 44 in which the identified acoustic wave resonator is replaced with an open impedance in that altered design.

Then, the design process is continued using the altered design in stage 46. In particular, the altered design is a specifically degraded model of the acoustic wave filter at the point of most likely failure.

When the design process ends, irrespective of the design it is based on, i.e. the initial design in stage 38 or the altered design in stage 46, a decision stage 40 is reached in which it is checked whether the required specification of the acoustic wave filter under design is met. If the required specification of the acoustic wave filter under design is found to be not met yet, the design process returns back to the starting stage 32 to find a new initial design.

The design method 30 ends in stage 42 when the finally adopted design is found to meet the boundary conditions of the required specification of the acoustic wave filter under design in the decision stage 40.

By purposefully taking into account the situation after a predicted resonator failure and analyzing a design in which the partial failure has already been factored in, the design method 30 is able to increase the design tolerance and the final yield of viable circuit designs of an acoustic wave filter.

FIG. 3B is a flow diagram of a design method 50 for an acoustic wave filter according to another embodiment. In a first stage 51, a first electrical circuit design of an acoustic wave filter is set up. The acoustic wave filter may, for example, be a ladder-type acoustic wave filter, a lattice-type acoustic wave filter, or a hybrid ladder-lattice-type acoustic wave filter. The acoustic wave filter may, for example, be employed as a band pass filter in which a first RF input/output port of the acoustic wave filter is a transmit port for a transmit filter or a receive port for a receive filter, and a second RF input/output port of the acoustic wave filter is an antenna port configured to be connected to an antenna. The first electrical circuit design of the acoustic wave filter includes a plurality of series acoustic wave resonators and a plurality of shunt acoustic wave resonators. The series acoustic wave resonators and/or shunt acoustic wave resonators may, for example, be bulk acoustic wave (BAW) resonators or Lamb wave resonators.

In a second stage 53, a first power-loss analysis for each of the plurality of series acoustic wave resonators and the plurality of shunt acoustic wave resonators of the first electrical circuit design is performed separately. The first power-loss analysis is performed, for example, in a frequency range between 410 MHz and 7.125 GHz, corresponding to FR1 of 5G NR.

Based on the first power-loss analysis, a third stage 55 involves determining which of the analyzed acoustic wave resonators of the first electrical circuit design displays transient power dissipation which is most likely to lead to a thermal run-away event. Then, depending on the determination result, a second electrical circuit design of the acoustic wave filter is set up in a fourth stage 57. The second electrical circuit design is based on the first electrical circuit design, that is, the arrangement and interconnections of the plurality of series acoustic wave resonators and the plurality of shunt acoustic wave resonators is maintained with the exception of the acoustic wave resonator determined to be most likely to fail is replaced with an open impedance.

In a fifth stage 59, the second electrical circuit design is used as basis for the performance of a second power-loss analysis for each of the remaining acoustic wave resonators of the second electrical circuit design separately. The second power-loss analysis is performed to determine which of the analyzed remaining acoustic wave resonators displays transient power dissipation which is most likely to lead to a thermal run-away event. The first and second power-loss analyses may, for example, be used to determine whether a transient power dissipation of the analyzed acoustic wave resonators exceeds a predetermined power dissipation threshold.

The routine of replacing acoustic wave resonators determined to be most likely to fail in the altered electrical circuit designs may be iterated. For example, based on the second electrical circuit design, a third electrical circuit design of the acoustic wave filter may be set up in which the acoustic wave resonator determined to be most likely to lead to a thermal run-away event in the second power-loss analysis is replaced with an open impedance. Then, a third power-loss analysis for each of the remaining acoustic wave resonators of the third electrical circuit design is separately performed to determine which of the analyzed remaining acoustic wave resonators displays transient power dissipation which is most likely to lead to a thermal run-away event. The iteration of the replacement routine may be repeated as many times as deemed to be useful in improving the resilience of the final design of the acoustic wave filter against thermal run-away events for the various acoustic wave resonators at risk of failing.

The design method 50 advantageously enables the development of an electrical circuit design of an acoustic wave filter which meets requirements of resilience against thermal run-away events on a deeper level. In particular, the final electrical circuit design may be optimized against selectively degraded variations of the acoustic wave filter which allows for a more directed design evolution taking into account the points of most likely failure under real operating conditions.

FIG. 3C is a flow diagram of a power-loss analysis method 60 for an acoustic wave filter according to another embodiment. In a first stage 61 of the power-loss analysis method 60, a frequency-dependent simulation of dissipated power of an electrical circuit design of an acoustic wave filter is initiated. The acoustic wave filter may, for example, be a ladder-type acoustic wave filter, a lattice-type acoustic wave filter, or a hybrid ladder-lattice-type acoustic wave filter. The acoustic wave filter may, for example, be employed as a band pass filter in which a first RF input/output port of the acoustic wave filter is a transmit port for a transmit filter or a receive port for a receive filter, and a second RF input/output port of the acoustic wave filter is an antenna port configured to be connected to an antenna. The first electrical circuit design of the acoustic wave filter includes a plurality of series acoustic wave resonators and a plurality of shunt acoustic wave resonators. The series acoustic wave resonators and/or shunt acoustic wave resonators may, for example, be bulk acoustic wave (BAW) resonators or Lamb wave resonators.

When the simulation reaches a stage in which transient power dissipation of a failing one of the plurality of series acoustic wave resonators and the plurality of shunt acoustic wave resonators exceeds a predetermined power dissipation threshold, the simulation is halted in a second stage 63.

Upon halting the simulation, the failing one of the plurality of series acoustic wave resonators and the plurality of shunt acoustic wave resonators is replaced with an open impedance in the electrical circuit design of the acoustic wave filter in a third stage 65. The frequency-dependent simulation of dissipated power may then be continued in a fourth stage 67, with the electrical circuit design of the acoustic wave filter in which the failing one of the plurality of series acoustic wave resonators and the plurality of shunt acoustic wave resonators has been replaced with an open impedance.

The power-loss analysis method 60 advantageously enables a simulation in which not only the resonator most prone to failure may be identified, but other resonators of secondary risk of failure as well.

Example filter topologies include without limitation ladder filters, lattice filters, hybrid ladder and lattice filters, filters that include ladder stages and a multi-mode SAW filter, and the like. Some example filter topologies will now be discussed.

FIG. 4 is a schematic diagram of a ladder filter 400 according to an embodiment. The ladder filter 400 includes series resonators 402a, 402b, 402c, and 402d and shunt resonators 402c, 402f, and 402g coupled between a first RF input/output port PORT1 and a second RF input/output port PORT2. The ladder filter 400 is an example topology of a band pass filter formed from bulk acoustic wave (BAW) resonators such as the BAW device 20 of FIG. 1. The ladder filter 400 can be arranged to filter an RF signal input to either of the RF input/output ports PORT1 and PORT2 and output at the respective other RF input/output port PORT2 or PORT1, respectively. The first RF input/output port PORT1 can be a transmit port for a transmit filter or a receive port for a receive filter. The second RF input/output port PORT2 can be an antenna port. Any suitable number of series acoustic wave resonators can be included in a ladder filter. Any suitable number of shunt acoustic wave resonators can be included in a ladder filter. Any suitable number of ladder stages can be implemented in a ladder filter in accordance with any suitable principles and advantages disclosed herein. Ladder stages can start with a series resonator or a shunt resonator from any input/output port of the ladder filter 400 as suitable.

As illustrated, one of the BAW resonators may be the weakest resonator and therefore prone to failure or defect due to dissipated power. As an example only, the series resonator 402a may be the weakest BAW resonator. However, it should be understood that in other examples of the ladder filter 400 another one of the BAW resonators may be identified as the weakest resonator. Assuming, for sake of argument, that the series resonator 402a is determined in the first power-loss analysis of the methods 30, 50, or 60 as illustrated in and explained in conjunction with any of the FIGS. 3A, 3B, and 3C, respectively, to display transient power dissipation which is most likely to lead to a thermal run-away event, the electrical circuit design as shown in FIG. 4 may be altered for a second power-loss analysis.

More particularly, the series resonator 402a in the electrical circuit design of the acoustic wave filter 400 shown in FIG. 4 may be replaced with an open impedance. Then, when the second power-loss analysis is performed, the second-to-weakest BAW resonator may be identified. Again, as an example only, the shunt resonator 402e may be the second-to-weakest BAW resonator. The determination of the shunt resonator 402e to display transient power dissipation which is most likely to lead to a thermal run-away event after the series resonator 402a has been replaced by an open impedance allows the identification of other resonators most susceptible to failure which initially only had a fairly low power dissipation in the first power-loss analysis. Therefore, the optimized simulation and design methods 30, 50, or 60 as illustrated in and explained in conjunction with any of the FIGS. 3A, 3B, and 3C, respectively, increase the reliability and resilience of the final design of acoustic wave filters such as the acoustic wave filter 400.

FIG. 5 is a schematic diagram of a lattice filter 90. The lattice filter 90 is an example topology of an acoustic wave filter formed from acoustic wave resonators. The lattice filter 90 can be arranged to filter an RF signal. As illustrated, the lattice filter 90 includes acoustic wave resonators RL1, RL2, RL3, and RL4. The acoustic wave resonators RL1 and RL2 are series resonators. The acoustic wave resonators RL3 and RL4 are shunt resonators. The illustrated lattice filter 90 has a balanced input and a balanced output. The lattice filter 90 can be implemented with different types of acoustic wave resonators in accordance with any suitable principles and advantages disclosed herein.

FIG. 6 is a schematic diagram of a hybrid ladder and lattice filter 100. The illustrated hybrid ladder and lattice filter 100 includes series acoustic wave resonators RL1, RL2, RH3, and RH4, and shunt acoustic wave resonators RL3, RL4, RH1, and RH2. The hybrid ladder and lattice filter 100 can be implemented with different types of acoustic wave resonators in accordance with any suitable principles and advantages disclosed herein.

FIG. 7 is a schematic diagram of an example of an acoustic wave ladder filter 220. The acoustic wave ladder filter 220 can be a transmit filter or a receive filter. The acoustic wave ladder filter 220 can be a band pass filter arranged to filter a radio frequency signal. The acoustic wave filter 220 can include series resonators R1, R3, R5, R7, and R9 and shunt resonators R2, R4, R6, and R8 coupled between a radio frequency input/output port RF_{I/O} and an antenna port ANT. The radio frequency input/output port RF_{I/O} can be a transmit port in a transmit filter or a receive port in a receive filter. One or more of the illustrated acoustic wave resonators can be BAW resonators in accordance with any suitable principles and advantages discussed herein. An acoustic wave ladder filter can include any suitable number of series resonators and any suitable number of shunt resonators.

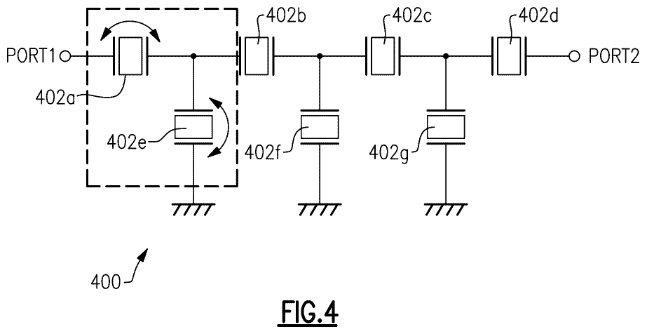

FIG. 8 is a schematic diagram of an example of a duplexer 230. The duplexer 230 can include a transmit filter 231 and a receive filter 232 coupled to each other at an antenna node ANT. A shunt inductor L1 can be connected to the antenna node ANT. The transmit filter 231 and the receive filter 232 can both be acoustic wave ladder filters in the duplexer 230.

The transmit filter 231 can filter a radio frequency signal and provide a filtered radio frequency signal to the antenna node ANT. A series inductor L2 can be coupled between a transmit input node TX and the acoustic wave resonators of the transmit filter 231. The illustrated transmit filter 231 can include acoustic wave resonators T01 to T09. One or more of these resonators can be BAW resonators in accordance with any suitable principles and advantages disclosed herein. The illustrated receive filter can include acoustic wave resonators R01 to R09. One or more of these resonators can be a BAW resonator in accordance with any suitable principles and advantages disclosed herein. The receive filter 232 can filter a radio frequency signal received at the antenna node ANT. A series inductor L3 can be coupled between the resonators and a receive output node RX. The receive output node RX of the receive filter 232 provides a radio frequency receive signal.

FIG. 9 is a schematic diagram of a multiplexer 235 that includes an acoustic wave filter designed in accordance with any of the methods and processes disclosed herein according to an embodiment. The multiplexer 235 can include a plurality of filters 236A to 236N coupled together at a common node COM. The plurality of filters can include any suitable number of filters including, for example, 3 filters, 4 filters, 5 filters, 6 filters, 7 filters, 8 filters, or more filters. Some or all of the plurality of filters can be acoustic wave filters. Each of the illustrated filters 236A, 236B, and 236N can be coupled between the common node COM and a respective input/output node RF_{I/O1}, RF_{I/O2}, and RF_{I/ON}.

In some instances, all filters of the multiplexer 235 can be receive filters. According to some other instances, all filters of the multiplexer 235 can be transmit filters. In various implementations, the multiplexer 235 can include one or more transmit filters and one or more receive filters. Accordingly, the multiplexer 235 can include any suitable number of transmit filters and any suitable number of receive filters. Each of the illustrated filters can be band pass filters having different respective pass bands.

The multiplexer 235 is illustrated with hard multiplexing with the filters 236A to 236N having fixed connections to the common node COM. In some other implementations, one or more of the filters of a multiplexer can be electrically connected to the common node by a respective switch. Any of such filters can include BAW resonators according to any suitable principles and advantages disclosed herein. The filters 236B to 236N of the multiplexer 235 can include one or more acoustic wave filters, one or more acoustic wave filters that include at least one surface or bulk acoustic wave resonator with a raised frame structure, one or more LC filters, one or more hybrid acoustic wave LC filters, or any suitable combination thereof.

Acoustic wave filters designed using the methods and processes disclosed herein can be implemented in a variety of packaged modules. Some example packaged modules will now be discussed in which any suitable principles and advantages of the acoustic wave filters disclosed herein can be implemented. Example packaged modules include one or more acoustic wave filters and one or more radio frequency amplifiers (e.g., one or more power amplifiers and/or one or more low noise amplifiers) and/or one or more radio frequency switches. The example packaged modules can include a package that encloses the illustrated circuit elements. The illustrated circuit elements can be disposed on a common packaging substrate. The packaging substrate can be a laminate substrate, for example.

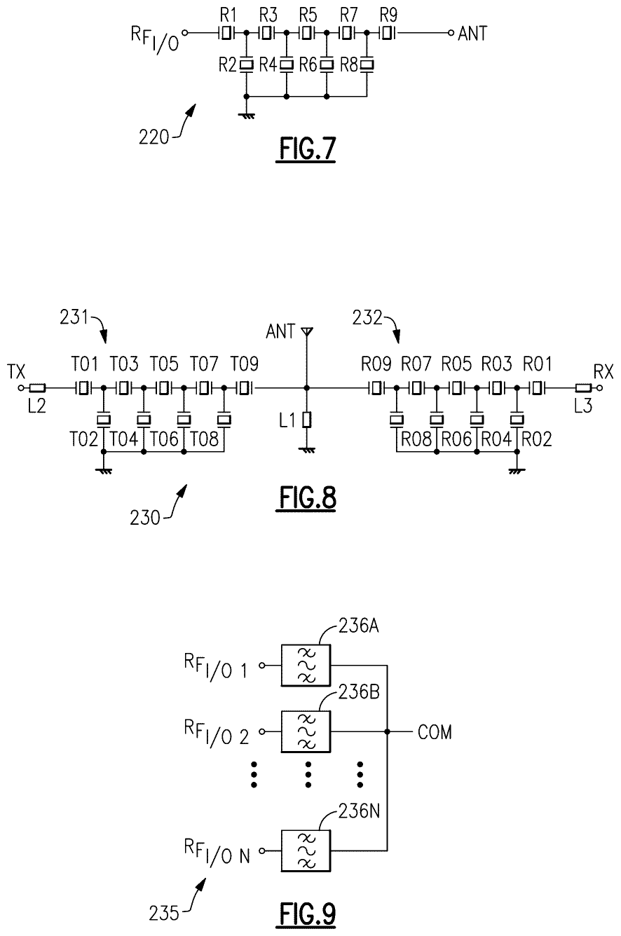

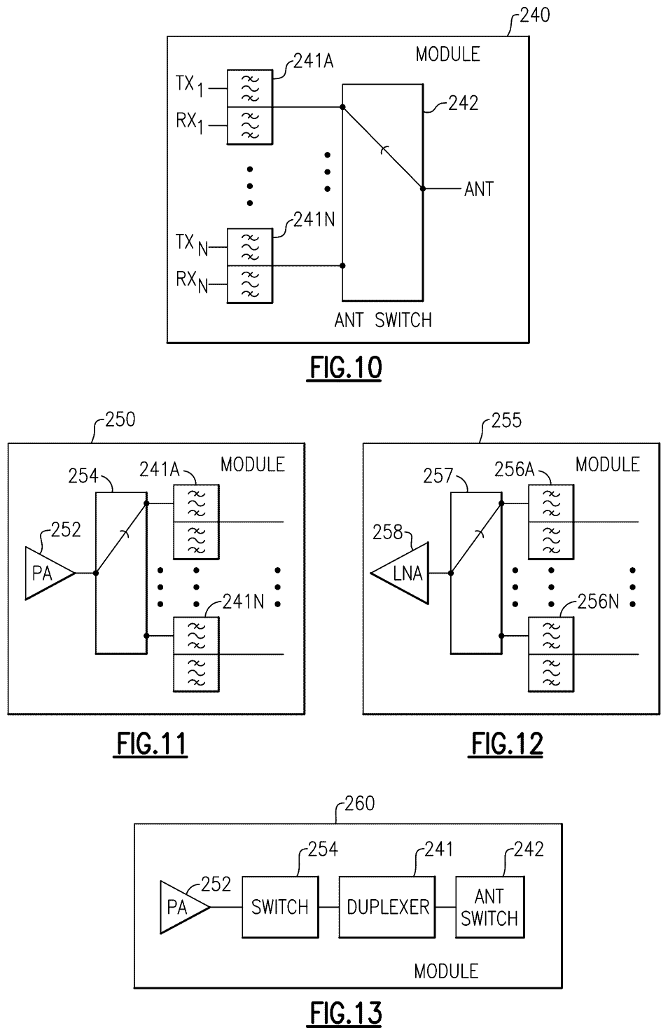

FIGS. 10, 11, 12, and 13 are schematic block diagrams of illustrative packaged modules according to certain embodiments. Certain example packaged modules can include one or more radio frequency amplifiers, such as one or more power amplifiers and/or one or more low noise amplifiers. Any suitable combination of features of these modules can be implemented with each other. While duplexers are illustrated in the example packaged modules of FIGS. 10, 11, 12 and 13, any other suitable multiplexer that includes a plurality of acoustic wave filters coupled to a common node can be implemented instead of one or more duplexers. For example, a quadplexer can be implemented in certain examples. Alternatively or additionally, one or more filters of a packaged module can be arranged as a transmit filter or a receive filter that is not included in a multiplexer.

FIG. 10 is a schematic block diagram of an example module 240 that includes duplexers 241A to 241N and an antenna switch 242. One or more filters of the duplexers 241A to 241N can include any suitable number of acoustic wave resonators and may be designed in accordance with any suitable principles and advantages discussed herein. Any suitable number of duplexers 241A to 241N can be implemented. The antenna switch 242 can have a number of throws corresponding to the number of duplexers 241A to 241N. The antenna switch 242 can electrically couple a selected duplexer to an antenna port of the module 240.

FIG. 11 is a schematic block diagram of an example module 250 that includes a power amplifier 252, a radio frequency switch 254, and duplexers 241A to 241N in accordance with one or more embodiments. The power amplifier 252 can amplify a radio frequency signal. The radio frequency switch 254 can be a multi-throw radio frequency switch. The radio frequency switch 254 can electrically couple an output of the power amplifier 252 to a selected transmit filter of the duplexers 241A to 241N. One or more filters of the duplexers 241A to 241N can include any suitable number of BAW resonators and may be designed in accordance with any suitable principles and advantages discussed herein. Any suitable number of duplexers 241A to 241N can be implemented.

FIG. 12 is a schematic block diagram of an example module 255 that includes filters 256A to 256N, a radio frequency switch 257, and a low noise amplifier 258 according to one or more embodiments. One or more filters of the filters 256A to 256N can include any suitable number of BAW resonators and may be designed in accordance with any suitable principles and advantages disclosed herein. Any suitable number of filters 256A to 256N can be implemented. The illustrated filters 256A to 256N can be receive filters. In some embodiments (not illustrated), one or more of the filters 256A to 256N can be included in a multiplexer that also includes a transmit filter. The radio frequency switch 257 can be a multi-throw radio frequency switch. The radio frequency switch 257 can electrically couple an output of a selected filter of filters 256A to 256N to the low noise amplifier 258. In some embodiments (not illustrated), a plurality of low noise amplifiers can be implemented. The module 255 can include diversity receive features in certain implementations.

FIG. 13 is a schematic block diagram of an example module 260 that includes a power amplifier 252, a radio frequency switch 254, a duplexer 241 that includes BAW resonators and that may be designed in accordance with one or more embodiments, and an antenna switch 242. The module 260 can include elements of the module 240 and elements of the module 250.

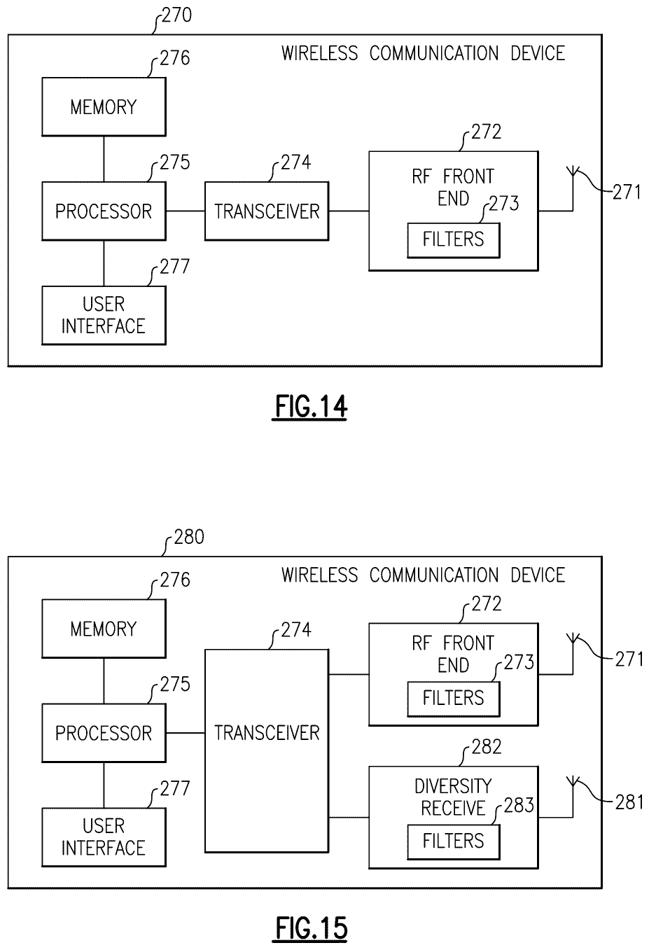

One or more filters with any suitable number of acoustic wave resonators can be implemented in a variety of wireless communication devices. FIG. 14 is a schematic block diagram of an example wireless communication device 270 that includes a filter 273 with one or more acoustic wave resonators designed in accordance with any suitable principles and advantages disclosed herein. The wireless communication device 270 can be any suitable wireless communication device. For instance, a wireless communication device 270 can be a mobile phone, such as a smartphone. As illustrated, the wireless communication device 270 includes an antenna 271, a radio frequency (RF) front end 272 that includes filter 273, an RF transceiver 274, a processor 275, a memory 276, and a user interface 277. The antenna 271 can transmit RF signals provided by the RF front end 272. The antenna 271 can provide received RF signals to the RF front end 272 for processing.

The RF front end 272 can include one or more power amplifiers, one or more low noise amplifiers, RF switches, receive filters, transmit filters, duplex filters, filters of a multiplexer, filters of a diplexer or other frequency multiplexing circuit, or any suitable combination thereof. The RF front end 272 can transmit and receive RF signals associated with any suitable communication standards. Any of the acoustic wave resonators disclosed herein can be implemented in filters 273 of the RF front end 272.

The RF transceiver 274 can provide RF signals to the RF front end 272 for amplification and/or other processing. The RF transceiver 274 can also process an RF signal provided by a low noise amplifier of the RF front end 272. The RF transceiver 274 is in communication with the processor 275. The processor 275 can be a baseband processor. The processor 275 can provide any suitable base band processing functions for the wireless communication device 270. The memory 276 can be accessed by the processor 275. The memory 276 can store any suitable data for the wireless communication device 270. The processor 275 is also in communication with the user interface 277. The user interface 277 can be any suitable user interface, such as a display.

FIG. 15 is a schematic diagram of a wireless communication device 280 that includes filters 273 in a radio frequency front end 272 and second filters 283 in a diversity receive module 282. The wireless communication device 280 is like the wireless communication device 270 of FIG. 14, except that the wireless communication device 280 also includes diversity receive features. As illustrated in FIG. 15, the wireless communication device 280 can include a diversity antenna 281, a diversity module 282 configured to process signals received by the diversity antenna 281 and including filters 283, and a transceiver 274 in communication with both the radio frequency front end 272 and the diversity receive module 282. One or more of the second filters 283 can include BAW resonators and may be designed in accordance with any suitable principles and advantages disclosed herein.

Acoustic wave devices disclosed herein can be included in a filter and/or a multiplexer arranged to filter a radio frequency signal in a fifth generation (5G) New Radio (NR) operating band within Frequency Range 1 (FR1). FR1 can range from 410 megahertz (MHz) to 7.125 gigahertz (GHz), for example, as specified in a current 5G NR specification. A filter arranged to filter a radio frequency signal in a 5G NR FR1 operating band can include one or more acoustic wave resonators and may be implemented in accordance with any suitable principles and advantages disclosed herein.

5G NR carrier aggregation specifications can present technical challenges. For example, 5G carrier aggregations can have wider bandwidth and/or channel spacing than fourth generation (4G) Long Term Evolution (LTE) carrier aggregations. Carrier aggregation bandwidth in certain 5G FR1 applications can be in a range from 120 MHz to 400 MHz, such as in a range from 120 MHz to 200 MHz. Carrier spacing in certain 5G FR1 applications can be up to 100 MHz. Methods and processes for designing acoustic wave filters as disclosed herein can increase design tolerances and yield potentials, in some embodiments.

Any of the embodiments described above can be implemented in association with mobile devices such as cellular handsets. The principles and advantages of the embodiments can be used for any systems or apparatus, such as any uplink wireless communication device, that could benefit from any of the embodiments described herein. The teachings herein are applicable to a variety of systems. Although this disclosure includes some example embodiments, the teachings described herein can be applied to a variety of structures. Any of the principles and advantages discussed herein can be implemented in association with RF circuits configured to process signals in a frequency range from about 30 kHz to 300 GHZ, such as in a frequency range from about 450 MHz to 8.5 GHZ.

Aspects of this disclosure can be implemented in various electronic devices. Examples of the electronic devices can include, but are not limited to, consumer electronic products, parts of the consumer electronic products such as packaged radio frequency modules, uplink wireless communication devices, wireless communication infrastructure, electronic test equipment, etc. Examples of the electronic devices can include, but are not limited to, a mobile phone such as a smart phone, a wearable computing device such as a smart watch or an car piece, a telephone, a television, a computer monitor, a computer, a modem, a hand-held computer, a laptop computer, a tablet computer, a microwave, a refrigerator, a vehicular electronics system such as an automotive electronics system, a stereo system, a digital music player, a radio, a camera such as a digital camera, a portable memory chip, a washer, a dryer, a washer/dryer, a copier, a facsimile machine, a scanner, a multi-functional peripheral device, a wrist watch, a clock, etc. Further, the electronic devices can include unfinished products.

Unless the context indicates otherwise, throughout the description and the claims, the words “comprise,” “comprising,” “include,” “including,” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as,” and the like, unless specifically stated otherwise, or otherwise understood within the context as used, is generally intended to convey that certain embodiments include, while other embodiments do not include, certain features, elements and/or states. The word “coupled,” as generally used herein, refers to two or more elements that may be either directly connected, or connected by way of one or more intermediate elements. Likewise, the word “connected,” as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

While certain embodiments have been described, these embodiments have been presented by way of example only, and are not intended to limit the scope of the disclosure. Indeed, the novel filters, devices, modules, radio frequency systems, wireless communication devices, apparatus, methods, and systems described herein may be embodied in a variety of other forms. Furthermore, various omissions, substitutions and changes in the form of the filters, multiplexer, devices, modules, radio frequency systems, wireless communication devices, apparatus, methods, and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and/or acts of the various embodiments described above can be combined to provide further embodiments. The accompanying claims and their equivalents are intended to cover such forms or modifications as would fall within the scope and spirit of the disclosure.

1. A design method for an acoustic wave filter, the method comprising:
setting up a first electrical circuit design of an acoustic wave filter having a plurality of series acoustic wave resonators and a plurality of shunt acoustic wave resonators;
performing a first power-loss analysis for each of the plurality of series acoustic wave resonators and the plurality of shunt acoustic wave resonators of the first electrical circuit design separately;
determining which of the analyzed acoustic wave resonators of the first electrical circuit design displays transient power dissipation which is most likely to lead to a thermal run-away event;
setting up, based on the first electrical circuit design, a second electrical circuit design of the acoustic wave filter in which the acoustic wave resonator determined to most likely lead to a thermal run-away event is replaced with an open impedance; and
performing a second power-loss analysis for each of the remaining acoustic wave resonators of the second electrical circuit design separately to determine which of the analyzed remaining acoustic wave resonators displays transient power dissipation which is most likely to lead to a thermal run-away event.

2. The method of claim 1 wherein the plurality of series acoustic wave resonators are bulk acoustic wave (BAW) resonators.

3. The method of claim 2 wherein the plurality of shunt acoustic wave resonators are bulk acoustic wave (BAW) resonators.

4. The method of claim 3 wherein the first and the second power-loss analyses are performed in a frequency range between 410 MHz and 7.125 GHz.

5. The method of claim 1 wherein determining which of the analyzed acoustic wave resonators of the first electrical circuit design displays transient power dissipation which is most likely to lead to a thermal run-away event includes determining whether a transient power dissipation of the analyzed acoustic wave resonators exceeds a predetermined power dissipation threshold.

6. The method of claim 1 wherein the acoustic wave filter is a ladder-type acoustic wave filter.

7. The method of claim 1 wherein the acoustic wave filter is a lattice-type or a hybrid ladder-lattice-type acoustic wave filter.

8. The method of claim 1 wherein the acoustic wave filter is a band pass filter.

9. The method of claim 8 wherein the acoustic wave filter includes a first RF input/output port configured as a transmit port for a transmit filter or a receive port for a receive filter, and a second RF input/output port configured as an antenna port to be connected to an antenna.

10. The method of claim 1 further comprising:
setting up, based on the second electrical circuit design, a third electrical circuit design of the acoustic wave filter in which the acoustic wave resonator determined to most likely lead to a thermal run-away event in the second power-loss analysis is replaced with an open impedance; and
performing a third power-loss analysis for each of the remaining acoustic wave resonators of the third electrical circuit design separately to determine which of the analyzed remaining acoustic wave resonators displays transient power dissipation which is most likely to lead to a thermal run-away event.

11. A power-loss analysis method for an acoustic wave filter, the method comprising:
initiating a frequency-dependent simulation of dissipated power of an electrical circuit design of an acoustic wave filter having a plurality of series acoustic wave resonators and a plurality of shunt acoustic wave resonators;
halting the simulation when the simulation reaches a stage in which transient power dissipation of a failing one of the plurality of series acoustic wave resonators and the plurality of shunt acoustic wave resonators exceeds a predetermined power dissipation threshold;
replacing, responsive to halting the simulation, the failing one of the plurality of series acoustic wave resonators and the plurality of shunt acoustic wave resonators with an open impedance in the electrical circuit design of the acoustic wave filter; and
continuing the frequency-dependent simulation of dissipated power with the electrical circuit design of the acoustic wave filter in which the failing one of the plurality of series acoustic wave resonators and the plurality of shunt acoustic wave resonators has been replaced with an open impedance.

12. The method of claim 11 wherein the plurality of series acoustic wave resonators are bulk acoustic wave (BAW) resonators.

13. The method of claim 12 wherein the plurality of shunt acoustic wave resonators are bulk acoustic wave (BAW) resonators.

14. The method of claim 11 wherein the frequency-dependent simulation of dissipated power is performed in a frequency range between 410 MHz and 7.125 GHz.

15. The method of claim 11 wherein the acoustic wave filter is a band pass filter.

16. The method of claim 15 wherein the acoustic wave filter includes a first RF input/output port configured as a transmit port for a transmit filter or a receive port for a receive filter, and a second RF input/output port configured as an antenna port to be connected to an antenna.

17. A computer program product comprising instructions which, when the program is executed by a computer, cause the computer to carry out the steps of the method of claim 11.

18. A non-transitory computer-readable storage medium comprising instructions which, when executed by a computer, cause the computer to carry out a power-loss analysis method for an acoustic wave filter, the method comprising:
initiating a frequency-dependent simulation of dissipated power of an electrical circuit design of an acoustic wave filter having a plurality of series acoustic wave resonators and a plurality of shunt acoustic wave resonators;
when the simulation reaches a stage in which transient power dissipation of a failing one of the plurality of series acoustic wave resonators and the plurality of shunt acoustic wave resonators exceeds a predetermined power dissipation threshold, halting the simulation;
upon halting the simulation, replacing the failing one of the plurality of series acoustic wave resonators and the plurality of shunt acoustic wave resonators with an open impedance in the electrical circuit design of the acoustic wave filter; and
continuing the frequency-dependent simulation of dissipated power with the electrical circuit design of the acoustic wave filter in which the failing one of the plurality of series acoustic wave resonators and the plurality of shunt acoustic wave resonators has been replaced with an open impedance.
